(19) United States
(12) Patent Application Publication
(10) Pub. No.: US 2024/0169258 A1
(43) Pub. Date: May 23, 2024

(54) TIME-SERIES ANOMALY DETECTION

(71) Applicant: Adobe Inc., San Jose, CA (US)

(72) Inventors: Wei Zhang, Great Falls, VA (US); David Thomas Arbour, Charlottesville, VA (US)

(73) Assignee: Adobe Inc., San Jose, CA (US)

(21) Appl. No.: 18/057,883

(22) Filed: Nov. 22, 2022

(51) Int. Cl. G06N 20/00

(52) U.S. Cl. CPC G06N 20/00

(57) ABSTRACT

In implementations of systems for time-series anomaly detection, a computing device implements an anomaly system to receive, via a network, time-series data describing continuously observed values separated by a period of time. The anomaly system computes updated estimated parameters of a predictive model for the time-series data by performing a rank one update on previously estimated parameters of the predictive model. An uncertainty interval for a future observed value is generated using the predictive model with the updated estimated parameters. The anomaly system determines that an observed value corresponding to the future observed value is outside of the uncertainty interval. An indication is generated that the observed value is an anomaly.

### BACKGROUND

Systems for anomaly detection monitor values of metrics to identify anomalous values of the metrics that deviate from normal or expected ranges of the values. Examples of anomalies include a sudden throughput drop (e.g., below a threshold) in a datacenter or an unusually high (e.g., above a threshold) processor/memory load on a server. By detecting the anomalies in these examples, it is possible to initiate a response to the detected anomalies such as to identify/resolve a cause of the abnormal or unexpected values and potentially avoid a loss of data/service.

### SUMMARY

Techniques and systems for time-series anomaly detection are described. In one example, a computing device implements an anomaly system to receive time-series data describing continuously observed values separated by a period of time. For example, the time-series data is received via a network in substantially real time such that the period of time is relatively short (e.g., a few seconds).

The anomaly system computes updated estimated parameters of a predictive model for the time-series data by performing a rank one update on previously estimated parameters of the predictive model. In an example, an uncertainty interval for a future observed value is generated using the predictive model with the updated estimated parameters. The uncertainty interval reflects an estimated probability of observing the future observed value based on extrapolated patterns of previously observed values described by the time-series data. The anomaly system determines that an observed value corresponding to the future observed value is outside of the uncertainty interval and generates an indication that the observed value is an anomaly.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ digital systems and techniques for time-series anomaly detection as described herein.

FIG. 2 depicts a system in an example implementation showing operation of an anomaly module for time-series anomaly detection.

FIG. 3 illustrates a representation of time-series anomaly detection.

FIG. 4 illustrates a representation of a predictive model.

FIG. 5 is a flow diagram depicting a procedure in an example implementation in which an observed value corresponding to a future observed value is outside of an uncertainty interval and an indication is generated that the observed value is an anomaly.

FIG. 6 is a flow diagram depicting a procedure in an example implementation in which an observed value corresponding to a future observed value is compared with a predicted value for the future observed value and an indication is generated that the observed value is an anomaly based on comparing the observed value with the predicted value.

FIG. 7 illustrates a representation of examples in which anomalies are detected in real-world time-series data.

FIG. 8 illustrates an example system that includes an example computing device that is representative of one or more computing systems and/or devices for implementing the various techniques described herein.

### DETAILED DESCRIPTION

Systems for detecting anomalies in time-series data do so by predicting a future value for the time-series using a model trained on previously observed values described by the time-series data. When a new observed value in the time-series is received, the new observed value is compared to the predicted future value to determine whether the new observed value corresponds to an anomaly. For example, if the new observed value is outside of a normal or expected range of values based on the predicted future value, then the new observed value is determined to be an anomaly in the time-series data.

Conventional systems for detecting anomalies in time-series data train a model using all previously observed values described by the time-series data (e.g., batch training), and then implement the trained model to predict a future value for the time-series. However, conventional systems suffer from limitations in both training and inference which render these systems impractical for use in scenarios in which the time-series data is received at a relatively high velocity (e.g., received in substantially real time) as describing observed values separated by a relatively short period of time (e.g., less than one minute). By training the model on training data describing all of the previously observed values in the time-series, an amount of time required to train the model (and a size of the training data) is increased for each new observed value included in the time-series. Because of these rapid increases in training time, conventional systems are not practical for use in scenarios in which the time-series data is received, e.g., in substantially real time.

In order to overcome this limitation, techniques and systems for online time-series anomaly detection are described. For example, a computing device implements an anomaly system to receive time-series data describing continuously observed values separated by a period of time that is relatively short (e.g., less than one minute). To detect anomalies in the time-series data, the anomaly system leverages a predictive model that is based on an approximate Gaussian process to predict a future observed value for the time-series described by the time-series data. The model includes a trend component that captures local, non-periodic aspects of the time-series as well as a seasonal component that captures recurrent, periodic aspects of the time-series.

In an embodiment, the anomaly system computes updated estimated parameters of the predictive model by performing a rank one update on previously estimated parameters of the predictive model. In one example, the anomaly system uses exponentially weighted updates that decay over time to compute the updated estimated parameters of the predictive model. For instance, the exponentially weighed updates cause the predictive model to predict future observed values for the time-series with a greater emphasis or weight on newer observed values and with a lesser emphasis or weight on older observed values. These weighted updates allow the model to adapt to variations in the time-series data while also preventing the model from overcorrecting in response to extreme observed values (e.g., extreme spikes) described by the time-series data.

The anomaly system generates an uncertainty interval for the future observed value using the predictive model with the updated estimated parameters. In an example, the anomaly system determines that an observed value corresponding to the future observed value is outside of the uncertainty interval and generates an indication that the observed value is an anomaly. By generating the indication of the detected anomaly in this manner, a response to the anomaly is initiable such that a cause of the anomaly is identified and resolved/mitigated.

The described systems for time-series anomaly detection are capable of accurately detecting anomalies in time-series data that is received at a relatively high velocity (e.g., received in substantially real time) which is not possible using conventional systems. This improvement is verified and validated on multiple different datasets. Additionally, by using the rank one update rules and the exponentially weighted updates, the described systems demonstrate similar accuracy as conventional systems in offline implementations (batch processing implementations) for detecting anomalies with training and inference times reduced by more than 95 percent relative to training and inference times of the conventional systems.

In the following discussion, an example environment is first described that employs examples of techniques described herein. Example procedures are also described which are performable in the example environment and other environments. Consequently, performance of the example procedures is not limited to the example environment and the example environment is not limited to performance of the example procedures.

### Example Environment

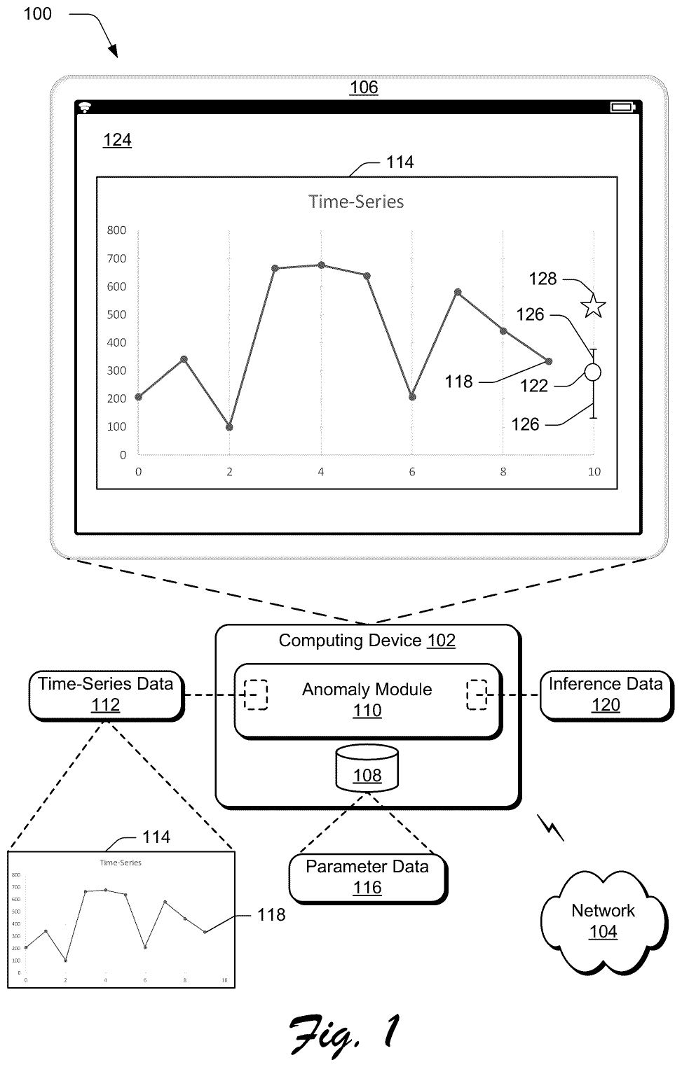

FIG. 1 is an illustration of an environment 100 in an example implementation that is operable to employ digital systems and techniques as described herein. The illustrated environment 100 includes a computing device 102 connected to a network 104. The computing device 102 is configurable as a desktop computer, a laptop computer, a mobile device (e.g., assuming a handheld configuration such as a tablet or mobile phone), and so forth. Thus, the computing device 102 is capable of ranging from a full resource device with substantial memory and processor resources (e.g., personal computers, game consoles) to a low-resource device with limited memory and/or processing resources (e.g., mobile devices). In some examples, the computing device 102 is representative of a plurality of different devices such as multiple servers utilized to perform operations “over the cloud.”

The illustrated environment 100 also includes a display device 106 that is communicatively coupled to the computing device 102 via a wired or a wireless connection. A variety of device configurations are usable to implement the computing device 102 and/or the display device 106. The computing device 102 includes a storage device 108 and an anomaly module 110.

The anomaly module 110 is illustrated as having, receiving, and/or transmitting time-series data 112 which describes a time-series 114. As shown, the time-series 114 depicts continuously observed values (y-axis) versus timestamps (x-axis) corresponding to observation times at which the continuously observed values were observed. For example, the continuously observed values are representative of network traffic between datacenters, virtual machines in use as part of a cloud-based service, numbers of active downloads of a particular font file from a font repository, and so forth.

In some examples, the continuously observed values are separated by a period of time which varies (e.g., is not constant), is relatively short (e.g., less than one second), is representative of observed values received in substantially real-time (e.g., a few hundred milliseconds), etc. In an example, the time-series 114 is missing some of the continuously observed values. In this example, the time-series data 112 is non-stationary (e.g., statistical properties of the time-series 114 change over time).

Consider an example in which the anomaly module 110 receives the time-series data 112 via the network 104, and the anomaly module 110 processes that time-series data 112 to detect anomalies. In general, an anomaly refers to a particular observed value that is outside of a normal or expected range of values (e.g., an uncertainty interval) at a specific time when the particular observed value is observed or received. For example, if the normal or expected range of values at the specific time is 1000±200, then any particular observed value between 800 and 1200 would not be an anomaly; however, a particular observed value of 1500 would be an anomaly. By detecting anomalies in the time-series data 112, it is possible for the anomaly module 110 to generate indications of the detected anomalies which facilitates resolution and/or mitigation of issues related to the anomalies.

In order to detect anomalies, the anomaly module 110 leverages a predictive model to predict future observed values (and corresponding uncertainty intervals) based at least partially on previously observed values included in the time-series 114. In an example, the predictive model is based on an approximate Gaussian process which includes a trend component that captures local, non-periodic aspects of the time-series 114 as well as a seasonal component that captures recurrent, periodic aspects of the time-series 114. The anomaly module 110 computes updated estimated parameters of the predictive model by performing a rank one update on previously estimated parameters of the predictive model which are illustrated as parameter data 116 stored on the storage device 108.

Initially, the anomaly module 110 uses a small number of observed values included in the time-series 114 to estimate an initial predictive model which is a batch process as all available observations are used for estimating. After estimating the initial predictive model (which may take several seconds), new observed values are received in the time-series data 112 and a rank one update is performed on previously estimated parameters of the initial predictive model based on a new observed value. For example, the rank one update computes the updated estimated parameters of the predictive model based on the previously estimated parameters and the new observed value.

Since the time-series data 112 is non-stationary in some examples, the anomaly module 110 computes the updated estimated parameters using exponentially weighted updates which decay over time. The exponentially weighed updates cause the predictive model to predict future observed values for the time-series 114 with a greater emphasis or weight on more recently observed values (e.g., newer observed values) and with a lesser emphasis or weight on less recently observed values (e.g., older observed values). By computing the updated estimated parameters of the predictive model using the exponentially weighted updates in this manner, the anomaly module 110 causes the predictive model to learn to accurately predict future observed values in scenarios in which the observed values of the time-series 114 change significantly, are missing, and/or are separated by a period of time which is variable/irregular.

Consider an example in which the observed values described by the time-series data 112 are received via the network 104 in substantially real time such that a period of time between the observed values is less than one minute (e.g., a second). In this example, after receiving/observing a most recent observed value 118 described by the time-series data 112, the anomaly module 110 computes the updated estimated parameters of the predictive model, and implements the predictive model with the updated estimated parameters to generate inference data 120. To do so in an example, instead of computing a new predictive model “from scratch” which is computationally expensive, the anomaly module 110 updates the predictive model and computes the updated estimated parameters of the predictive model by performing a rank one update on the previously estimated parameters of the predictive model based on the most recent observed value 118 described by the time-series data 112. In this example, by performing the rank one update on the previously estimated parameters of the predictive model is computationally efficient compared to computing a new predictive model “from scratch” as in conventional techniques.

After computing the updated estimated parameters of the predictive model in this manner, the anomaly module 110 implements the predictive model with the updated estimated parameters to generate the inference data 120 as describing a future observed value 122 which is displayed relative to the time-series 114 in a user interface 124 of the display device 106. The inference data 120 also describes an uncertainty interval 126 for the future observed value 122 which represents a normal or expected range of values for the future observed value 122 based on the updated estimated parameters. For example, the anomaly module 110 receives the time-series data 112 as describing an observed value 128 corresponding to the future observed value 122 which is also displayed in the user interface 124.

As shown, the observed value 128 is outside of the uncertainty interval 126. As a result of this, the anomaly module 110 detects the observed value 128 as an anomaly. In some examples, the anomaly module 110 generates an indication that the observed value 128 is detected as an anomaly such that a response to the detected anomaly is initiable to resolve or mitigate a cause of the detected anomaly. By performing the rank one update on the previously estimated parameters to compute the updated estimated parameters of the predictive model and also leveraging the exponentially weighted updates, the anomaly module 110 capable of implementing the model to accurately predict the future observed value 122 within a short enough amount of time to detect the observed value 128 as the anomaly in online applications such as in scenarios in which the time-series data 112 is received in substantially real time. This is not possible in conventional systems that require multiple seconds (e.g., 5 seconds) for training and inference.

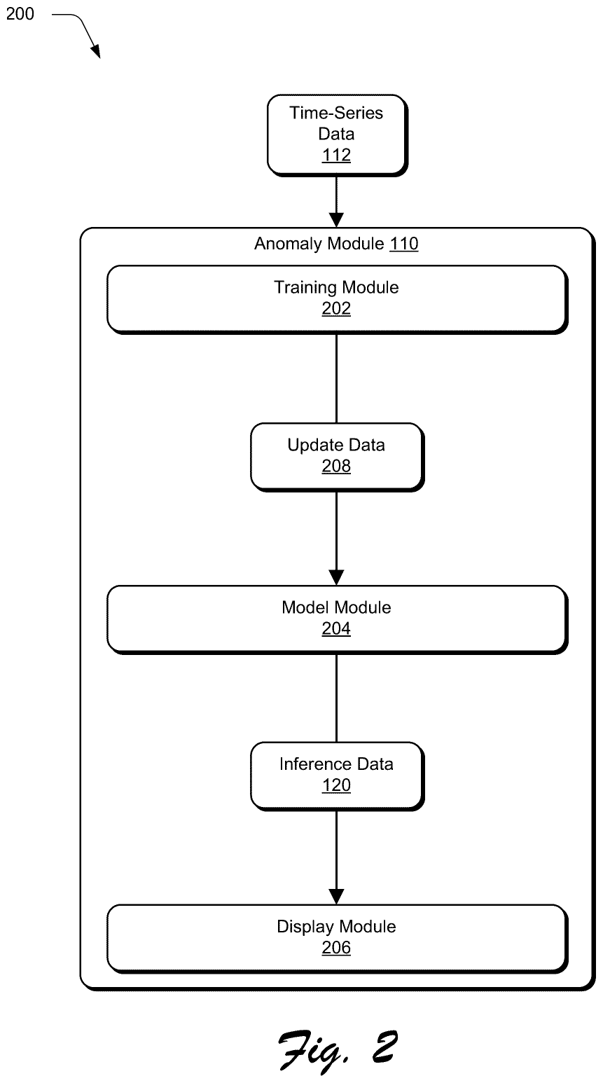

FIG. 2 depicts a system 200 in an example implementation showing operation of an anomaly module 110. The anomaly module 110 is illustrated to include a training module 202, a model module 204, and a display module 206. For example, the training module 202 receives and processes the time-series data 112 to generate update data 208.

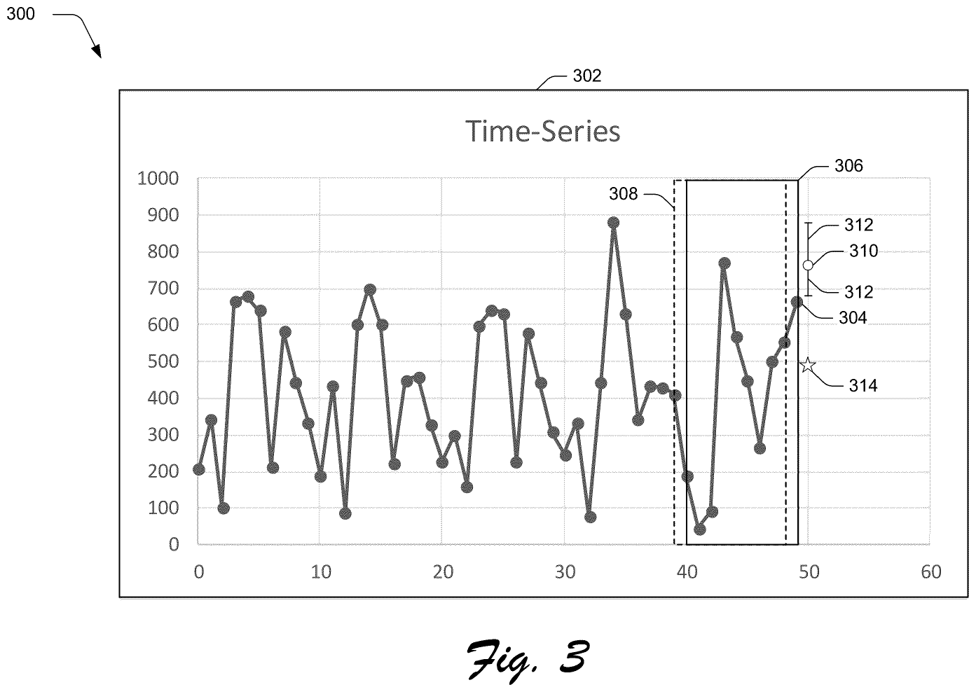

FIG. 3 illustrates a representation 300 of time-series anomaly detection. As shown, the representation 300 includes a time-series 302 of continuously observed values y∈ [symbol] (y-axis) and timestamps t₁, . . . , tₙ∈ [symbol] (x-axis) indicating times at which corresponding observed values are received/observed. The observed values of the time-series 302 are representative of a wide variety of different types of observable values. For example, the observed values of the time-series 302 represent numbers of templates that are modified and exported as part of a content creation service, numbers of client devices using an analytics service at times described by corresponding timestamps, values of an analytics metric being monitored at a particular client device using the analytics service, and so forth. In some examples, the observed values of the time-series 302 are received in substantially real-time via the network 104 such that the observed values are separated by a period of time which is variable, less than one second, only a few hundred milliseconds, etc. It is possible that the time-series 302 is stationary (e.g., statistical properties of the observed values are constant) or it is possible that the time-series 302 is non-stationary (e.g., statistical properties of the observed values change over time).

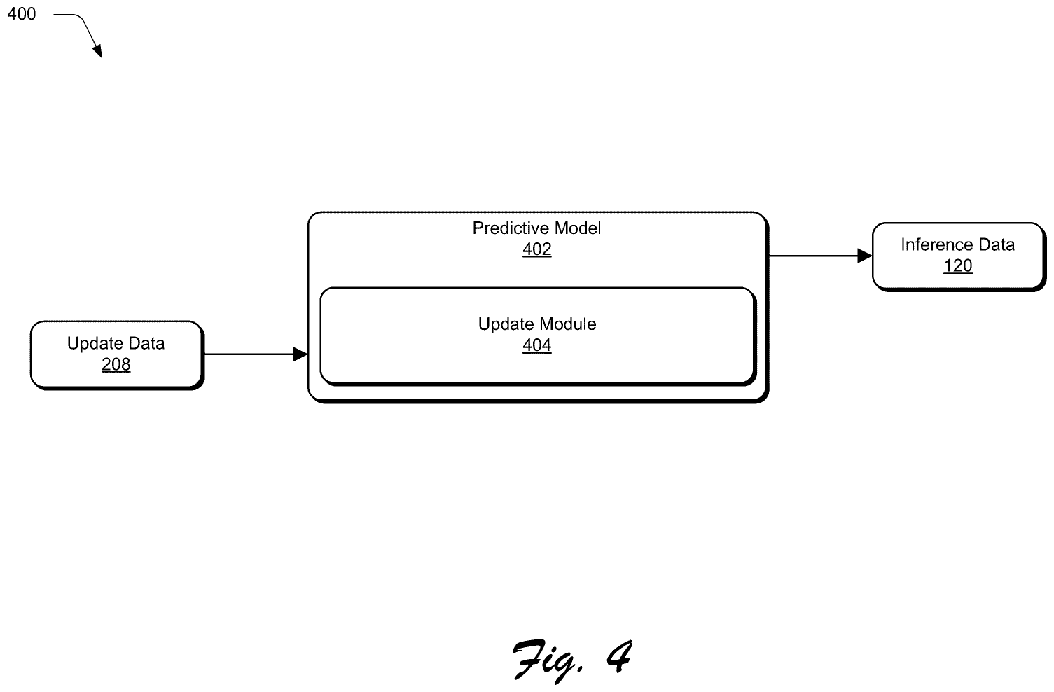

FIG. 4 illustrates a representation 400 of a predictive model 402. The predictive model 402 is illustrated to include an update module 404 which receives the update data 208 in one example. In some examples, the predictive model 402 includes a machine learning model. As used herein, the term “machine learning model” refers to a computer representation that is tunable (e.g., trainable) based on inputs to approximate unknown functions. By way of example, the term “machine learning model” includes a model that utilizes algorithms to learn from, and make predictions on, known data by analyzing the known data to learn to generate outputs that reflect patterns and attributes of the known data. According to various implementations, such a machine learning model uses supervised learning, semi-supervised learning, unsupervised learning, reinforcement learning, and/or transfer learning. For example, the machine learning model is capable of including, but is not limited to, clustering, decision trees, support vector machines, linear regression, logistic regression, Bayesian networks, random forest learning, dimensionality reduction algorithms, boosting algorithms, artificial neural networks (e.g., fully-connected neural networks, deep convolutional neural networks, or recurrent neural networks), deep learning, etc. By way of example, a machine learning model makes high-level abstractions in data by generating data-driven predictions or decisions from the known input data.

Consider an example in which the anomaly module 110 includes the predictive model 402 for predicting future observed values for the time-series 302 based on a Gaussian process which is representable as:

$${y}_{i} ∼ {{\sum }^{m}}_{q} {f}_{q} ( {g}_{q} ( {t}_{i} ) ) + ϵ$$

where: f represents a function, f: [symbol] ^{d}→ [symbol] , g represents a feature transformation, g: [symbol] → [symbol] ^{m}, and ϵ is a mean-zero, bounded random variable.

Continuing the example, the above equation corresponds to a Gaussian process model with summed covariances:

Y˜ [symbol] (0,\tilde{K})

where: \tilde{K} i,j=Σ_{q}^{m}k_{q}(g(xᵢ),g(xⱼ)).

The Gaussian process model includes a trend component that captures local, non-periodic aspects of the time-series 302 as well as a seasonal component that captures recurrent, periodic aspects of the time-series 302. For example, the trend component includes a linear portion and an autoregressive component. In this example, the linear portion corresponds to a linear model f(tᵢ)=βtᵢ, e.g., where an identity feature transformation is implicit. The autoregressive component is represented as a stationary kernel in one example such as:

$$k ( t , {t}^{′} ) = αexp ( \frac{{‖ t - {t}^{′} ‖}^{2}}{ρ} )$$

where: α represents a variance of the kernel and a prior variance α determines an extent to which a difference between inputs affects an observed outcome; and ρ represents a lengthscale of the kernel which parameterizes a smoothness of the time-series 302 and defines an extent to which past observed values provide information about a current observed value.

Alternatively, for example, an AR(k) function is assumable directly such that an implicit covariance is given using Yule-Walker equations.

In an example, the seasonal component that captures recurrent, periodic aspects of the time-series 302 is implemented as a periodic kernel. In this example, the periodic kernel is representable as:

$$k ( x , {x}^{′} ) = exp - \frac{{ω}_{0} ( x - {x}^{′} ) - 1}{{ρ}^{2}}$$

Additionally or alternatively, the periodic component is representable as a

squared exponential kernel where a sin function has first been applied to the input:

$$k ( x , {x}^{′} ) = exp \frac{{‖ sin ( x ) - sin ( {x}^{′} ) ‖}^{2}}{{ρ}^{2}}$$

The Gaussian process model described in the previous example is characterized by training and prediction times which increase according to:

O(T³)

where: T represents a total number of observed time points.

As a result of this complexity, the Gaussian process model is limited in scenarios in which a velocity of incoming data is relatively high. To address this, the anomaly module 110 leverages an approximation of the kernels using samples from a Fourier basis. In one example, this approach employs Bochner's theorem which states that a continuous, time-invariant, kernel is a positive-definite function if and only if the kernel is a Fourier transform of some non-negative measure. In this example, stationary kernels are approximated in the following manner.

Draw D samples from some distribution, and a normal distribution corresponds to approximating the Gaussian kernel:

[symbol]

˜ [symbol] (0,σ²)

where: σ² represents variance corresponding to a bandwidth of the kernel.

Construct the Fourier basis explicitly as:

$$ϕ ( {x}_{j} ) = \sqrt{\frac{2}{d}} [ cos ( {𝓌}_{1}^{T} {x}_{j} ) , sin ( {𝓌}_{1}^{T} {x}_{j} ) , ... , cos ( {𝓌}_{\frac{d}{2}}^{T} {x}_{j} ) , sin ( {𝓌}_{\frac{d}{2}}^{T} {x}_{j} ) ]$$

where: cases of a radial basis function and a squared exponential interpretation of the periodic kernel are approximated using random features and in a case of a linear kernel, the transformation becomes vacuous and reduces to an identify function.

Using random features rather than an explicit kernel function provides a reduction that facilitates more efficient batch training and also admits an online updating scheme which does not require storage of past observations. Specifically, performing a maximum a posteriori estimate and applying a Woodbury identity reduces the implementation to Bayesian linear regression by observing:

$$\hat{μ} = {{K}_{{x}^{′} , x} ( K + σ𝕀 )}^{- 1} y = ϕ ( {x}^{′} ) {ϕ ( x )}^{T} {( ϕ ( x ) {ϕ ( x )}^{T} + σ𝕀 )}^{- 1} y = ϕ ( {x}^{′} ) {( {ϕ ( x )}^{T} ϕ ( x ) + σ𝕀 )}^{- 1} {ϕ ( x )}^{T} y$$

where: ϕ is a random feature transformation; and σ² is a prior on independent noise.

Notably, this reduces a computational cost of estimation from a cubic cost of a number of observations to a cost based on a number of random features used. Because the example implementation is Bayesian linear regression, it is flexible and adaptable to incorporate features and components, e.g., by creating a new feature transformation. This flexibility is an improvement relative to conventional implementations such as in implementations which specify a model entirely a priori, and the improved implementation more closely models Gaussian process implementations which search through a space of flexible feature transformations (expressed as covariant functions).

Additionally, since the implementation is reduced to Bayesian linear regression, the implementation is further improvable to provide rank-one updates which are processable in a streaming manner without needing to retain prior observations. For example, the predictive model 402 leverages the update module 404 to provide rank-one updates. In an example, this is representable as:

$$p ( {y}_{t} \vert {x}_{t} , β , σ ) = \frac{1}{Z} exp ( \frac{- {( {β}^{T} {x}_{t} - {y}_{t} )}^{2}}{2 {σ}^{2}} )$$

where: β is a regression coefficient; σ² is noise; and Z generally denotes a partition function which includes terms not directly relevant for optimization. Further, assuming a multivariate Gaussian prior on β:

$$p ( β ) ∼ N ( μ , \sum ) = \frac{1}{Z} exp ( - \frac{1}{2} {( β - μ )}^{T} {\sum }^{- 1} ( β - μ ) )$$

It is possible to apply Bayes' rule to arrive at the joint probability of the relevant parameters given the features.

$$p ( β ) p ( {y}_{t} \vert {x}_{t} , β ) = \frac{1}{Z} exp ( \frac{- {( {β}^{T} {x}_{t} - {y}_{t} )}^{2}}{2 {σ}^{2}} - \frac{1}{2} {( β - μ )}^{T} {\sum }^{- 1} ( β - μ ) )$$

This formulation is usable to derive an online updating rule for the regression coefficients. For example, consider an equivalent natural parameterization of the multivariate Gaussian prior on β:

$$p ( β ) = \frac{1}{Z} exp ( {J}^{T} β - \frac{1}{2} {β}^{T} P β )$$

using corresponding natural parameters for the multivariate Gaussian distribution, P=and Σ⁻¹ and J=Σ⁻¹μ

Using this parameterization, the joint probability is representable as:

$$p ( β ) p ( {y}_{t} \vert {x}_{t} , β ) = \frac{1}{Z} exp ( \frac{- {( {β}^{T} {x}_{t} - {y}_{t} )}^{2}}{2 {σ}^{2}} + {J}^{T} β - \frac{1}{2} {β}^{T} P β )$$

After regrouping terms inside of the exponent, it is possible to rewrite the

update rule for the distribution of β using rank one update operations:

$${J}^{′} = J + \frac{{y}_{t} {x}_{t}^{T}}{{σ}^{2}}$$

$${P}^{′} = P + \frac{{y}_{t} {x}_{t}^{T}}{{σ}^{2}}$$

where: σ² is the variance of the observation noise as before.

Notably, this update is performable by employing a Sherman-Morrison formula for rank one updates. After the update, new values for f are found by taking a posterior mean giving by β=μ=ΣJ which corresponds to taking a most probable element from the distribution. Because of the ability to use the Sherman-Morrison formula, time complexity (e.g., a computation cost) of this update is O(N²) where N is a number of basis functions.

In order for the model to adapt to changes in non-stationary data, an exponential weighting mechanism is leveraged which places a greater emphasis on more recent observations and introduces a “forgetting” process for older observations. As previously noted, a stationary assumption for Gaussian processes is violated due to exogenous factors in many online monitoring settings. In order to accommodate such shifts, the Bayesian linear regression model described above is modified such that the parameters progressively ignore past observations. For example, let α∈[0,1] define a “forgetting” factor. The update rules derived above are modifiable as:

$${J}^{′} ( α ) = α J + ( 1 - α ) \frac{{y}_{t} {x}_{t}^{T}}{{σ}^{2}}$$

$${P}^{′} ( α ) = α P + ( 1 - α ) \frac{{x}_{t} {x}_{t}^{T}}{{σ}^{2}}$$

Although the above updates are well suited for cases in which regularly spaced observations are observed, exponentially weighted moving averages accommodate for irregularly spaced observed data. In one example, the definition of α is considered from a perspective of a half life of an observation:

$$α = 1 - {e}^{log ( \frac{1}{2} ) \frac{Δ}{H}}$$

where: Δ represents a difference between a current observation and a previous observation, e.g., Δ=|tᵢ−tᵢ₋₁|; and H is a half-life of an observation.

Inserting this modified definition into the prior derivation for update rules results in:

$${J}^{′} ( α ) = ( 1 - {e}^{log ( \frac{1}{2} ) \frac{Δ}{H}} ) J + ( - {e}^{log ( \frac{1}{2} ) \frac{Δ}{H}} ) \frac{{y}_{t} {x}_{t}^{T}}{{σ}^{2}}$$

$${P}^{′} ( α ) = ( 1 - {e}^{log ( \frac{1}{2} ) \frac{Δ}{H}} ) P + ( - {e}^{log ( \frac{1}{2} ) \frac{Δ}{H}} ) \frac{{x}_{t} {x}_{t}^{T}}{{σ}^{2}}$$

In one example, the training module 202 receives the time-series data 112 as describing the time-series 302. In an example in which the predictive model 402 includes a machine learning model, the training module 202 is capable of training the predictive model 402 to generate predicted values for future observed values using a variety of different types of training data. In a first example in which the predictive model 402 includes a long short-term memory model, the training module 202 trains the predictive model 402 on training data describing a set of previously observed values included in the time-series 302. In the first example, the predictive model 402 learns to generate the predicted values by learning an order dependency based on the set of previously observed values described by the training data. In a second example in which the predictive model 402 includes a convolutional neural network, the training model 202 trains the predictive model 402 using labeled training data that includes examples of correctly predicted values for future observed values and examples of incorrectly predicted values for future observed values. In the second example, the training module 202 implements the predictive model 402 to generate a predicted value based on the labeled training data, and the update module 404 modifies weights of the predictive model 402 based on the predicted value and a label of the labeled training data. Thus, the predictive model 402 learns to correctly generate predicted values for future observed values based on the modification of the weights.

In an example in which the predictive model 402 includes the approximate Gaussian process model, the training model 202 trains the predictive model 402 using the time-series data 112, and the update module 404 estimates initial parameters for the predictive model 404 based on all previously observed values included in the timer series 302. In this example, the training module 202 then processes the time-series data 112 to compute updated estimated parameters of the predictive model 402 based on a most recent observed value 304 described by the time-series data 112. To do so in one example, the training module 202 shifts a sliding window to a current position 306 from a previous position 308. For example, the sliding window defines a subset of recent observed values included in the time-series 302 such as a most recent 10 observed values, a most recent 20 observed values, a most recent 30 observed values, and so forth.

The observed values included in the sliding window represent a complete set of training data for training the approximate Gaussian process model included in the predictive model 402. For instance, the observed values included in the sliding window in the previous position 308 represent a previous instance of training data while the observed values included in the sliding window in the current position 306 represent a current instance of training data. Each time the training module 202 receives the time-series data 112 as describing a new observed value (e.g., the most recent observed value 304 in the representation 300), the training module 202 shifts the sliding window to define a new subset of the observed values that includes the new observed value.

As described above, rather than computing a new predictive model 402 for the current position 306 of the sliding window “from scratch” as in conventional techniques, the training module 202 implements the update module 404 to update the predictive model 402. To do so in one example, the update module 404 performs a rank one update on the previously estimated parameters of the predictive model 402. The training module 202 then generates the update data 208 as describing the updated estimated parameters of the predictive model 402 (e.g., the update data 208 describes the updated predictive model 402).

For example, the model module 204 receives and processes the update data 208 to generate inference data 120 by implementing the approximate Gaussian process model included in the predictive model 402 with the updated estimated parameters to generate a future observed value 310 and an uncertainty interval 312 for the future observed value 310. The model module 204 generates the inference data 120 as describing the future observed value 310 and the uncertainty interval 312. In some examples, the model module 204 implements the predictive model 402 to generate the inference data 120.

In an example, the display module 206 receives and processes the inference data 120 to detect an anomaly in the time-series 302. In this example, the display module 206 determines whether or not an observed value 314 corresponding to the future observed value 310 is outside of the uncertainty interval 312. If the observed value 314 is within the uncertainty interval 312, then the display module 206 does not detect the observed value 314 as an anomaly.

In the illustrated example, the observed value 314 is outside of the uncertainty interval 312, and the display module 206 detects the observed value 314 as an anomaly. For example, the display module 206 generates an indication that the observed value 314 is an anomaly. In an example, the display module 206 communicates the indication (e.g., via the network 104) such that a response to the detected anomaly is initiable (e.g., to resolve or mitigate a cause of the detected anomaly). The training module 202 then computes new updated estimated parameters of the predictive model 402 based on the observed value 314, and the model module 204 implements the approximate Gaussian process model included in the predictive model 402 with the new updated estimated parameters.

By executing the update rules described above, the anomaly module 110 is capable of training the predictive model 402 and/or the approximate Gaussian process model and implementing the trained approximate Gaussian process model to generate the inference data 120 in an amount of time which is less than a period of time separating the observed values included in the time-series 302 even in scenarios in which the time-series data 112 is received in substantially real time (e.g., observed values separated by a few seconds). Furthermore, by using the exponentially weighted updates described above (e.g., having a decay rate based on a fraction of the period of time separating the observed values), the anomaly module 110 is also capable of implementing the predictive model 402 and/or the approximate Gaussian process model to accurately predict the future observed value 310 and the uncertainty interval 312 even in scenarios in which the time-series data 112 is non-stationary. This is not possible using conventional systems which require multiple seconds to train and implement a model and which are also not capable of accurately predicting future values based on non-stationary time-series data.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable individually, together, and/or combined in different ways. Thus, individual functionality, features, and concepts described in relation to different example environments, devices, components, figures, and procedures herein are usable in any suitable combinations and are not limited to the particular combinations represented by the enumerated examples in this description.

### Example Procedures

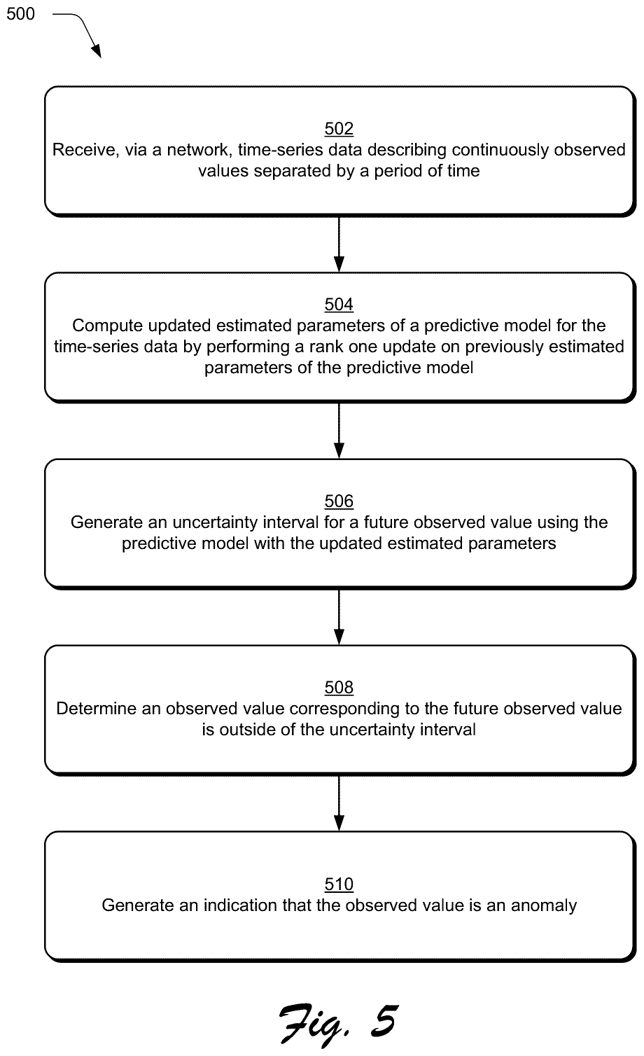

The following discussion describes techniques which are implementable utilizing the previously described systems and devices. Aspects of each of the procedures are implementable in hardware, firmware, software, or a combination thereof The procedures are shown as a set of blocks that specify operations performed by one or more devices and are not necessarily limited to the orders shown for performing the operations by the respective blocks. In portions of the following discussion, reference is made to FIGS. 1-4. FIG. 5 is a flow diagram depicting a procedure 500 in an example implementation in which an observed value corresponding to a future observed value is outside of an uncertainty interval and an indication is generated that the observed value is an anomaly.

Time-series data is received via a network describing continuously observed values separated by a period of time (block 502). For example, the computing device 102 implements the anomaly module 110 to receive the time-series data. Updated estimated parameters of a predictive model for the time-series data are computed by performing a rank one update on previously estimated parameters of the predictive model (block 504). In some examples, the anomaly module 110 computes the updated estimated parameters of the predictive model.

An uncertainty interval for a future observed value is generated using the predictive model with the updated estimated parameters (block 506). In one example, the anomaly module 110 generates the uncertainty interval for the future observed value. It is determined that an observed value corresponding to the future observed value is outside of the uncertainty interval (block 508). The anomaly module 110 determines that the observed value corresponding to the future observed value is outside of the uncertainty interval in some examples. An indication is generated that the observed value is an anomaly (block 510). For example, the anomaly module 110 generates the indication.

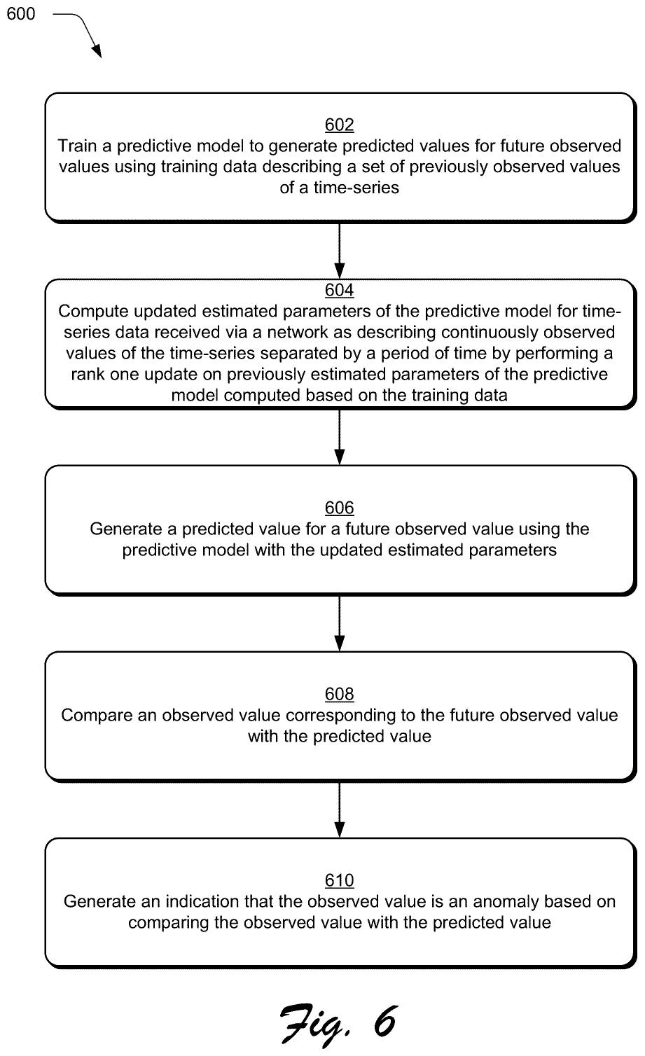

FIG. 6 is a flow diagram depicting a procedure 600 in an example implementation in which an observed value corresponding to a future observed value is compared with a predicted value for the future observed value and an indication is generated that the observed value is an anomaly based on comparing the observed value with the predicted value. A predictive model is trained to generate predicted values for future observed values using training data describing a set of previously observed values of a time-series (block 602). For example, anomaly module 110 trains the predictive model using the training data. Updated estimated parameters of the predictive model for time-series data received via a network as describing continuously observed values of the time-series separated by a period of time are computed by performing a rank one update on previously estimated parameters of the predictive model computed based on the training data (block 604). The computing device 102 implements the anomaly module 110 to compute the updated estimated parameters of the predictive model in one example.

A predicted value for a future observed value is generated using the predictive model with the updated estimated parameters (block 606). For example, the anomaly module 110 generates the predicted value for the future observed value using the predictive model with the updated estimated parameters. An observed value corresponding to the future observed value is compared with the predicted value (block 608). In an example, the anomaly module 110 compares the observed value corresponding to the future observed value with the predicted value. An indication is generated that the observed value is an anomaly based on comparing the observed value with the predicted value (block 610). In some examples, the anomaly module 110 generates the indication that the observed value is an anomaly.

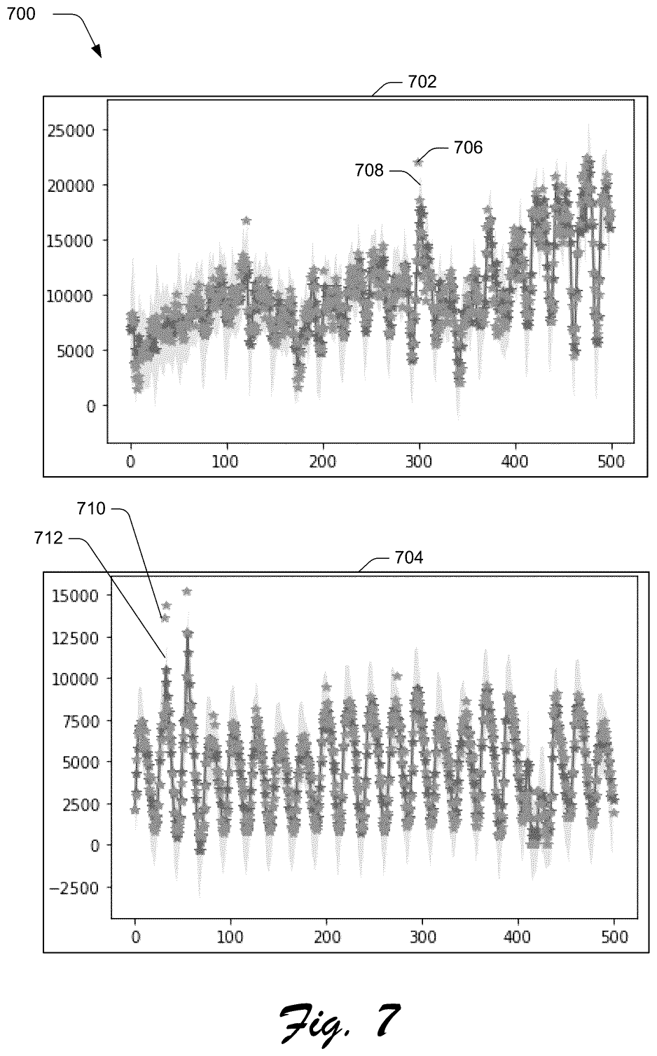

FIG. 7 illustrates a representation 700 of examples in which anomalies are detected in real-world time-series data. As shown, the representation 700 includes a first example 702 and a second example 704. In the first example 702, an anomaly 706 is detected as being outside of an uncertainty interval 708 predicted for a future value corresponding to the anomaly by the anomaly module 110. Since the anomaly module 110 leverages the exponentially weighted updates, the approximate Gaussian process model does not overcorrect when updated estimated parameters are computed from previously estimated parameters that include the anomaly 706. Similarly, in the second example 704, an anomaly 710 is detected as being outside of an uncertainty interval 712 predicted for a future value corresponding to the anomaly 710 by the anomaly module 110. As shown in the second example 704, after detecting the anomaly 710, the approximate Gaussian process model does not overcorrect, e.g., when generating inference data 120 based on updated estimated parameters computed by performing a rank one update on previously estimated parameters that include the anomaly 710.

The described systems for time-series anomaly detection were evaluated against a conventional system for anomaly detection in both batch (offline) and online settings. For batch experiments, three metrics were considered: (1) mean absolute error (MAE) on held out data; (2) coverage; and (3) running time in both training and inference. These metrics were evaluated on an airline dataset and a CO₂ dataset.

The airline dataset contains numbers of airline passengers recorded monthly between 1949 and 1961. Training was performed on the described systems for time-series anomaly detection and the conventional system for anomaly detection in batch mode (no online updating) using the first 96 months with a forecast period occurring over the following 48 months. The CO₂ dataset contains monthly average atmospheric carbon dioxide concentrations at the Mauna Loa Observatory, Hawaii. The first 200 months were used for training with the following 301 months used for testing.

For the airline dataset, the described systems for time-series anomaly detection demonstrated MAE of 438 and coverage of 0.96 while the conventional system for anomaly detection demonstrated MAE of 457 and coverage of 0.99. For the CO₂ dataset, the described systems for time-series anomaly detection demonstrated MAE of 9.6 and coverage of 0.98, and the conventional system for anomaly detection demonstrated MAE of 9.4 and coverage of 0.99. On both datasets, the training and inference time for the described systems for time-series anomaly detection was approximately half of the training an inference time for the conventional system for anomaly detection.

For online experiments, average root mean squared error and MAE were assessed for the described systems for time-series anomaly detection and the conventional system for anomaly detection on multiple datasets included in AmazonCloudWatch service metrics provided in the Numenta anomaly benchmark data collection. Example metrics include central processor unit (CPU) utilization, network bytes in, and disk read bytes. Both systems were trained on a sliding window of 20 observed values and assessed on forecasts over the following 10 periods across the multiple datasets. The results of these experiments indicate that the described systems for time-series anomaly detection consistently outperform the conventional system for anomaly detection which train only on new batches of observations as they are observed. This superior performance is likely due to the online nature of the training process and the ability of the described systems to maintain a running state over time and also because the local trend of the described systems follows an exponentially weighted process rather than uniformly spaced piecewise linear trends used by the conventional system.

### Example System and Device

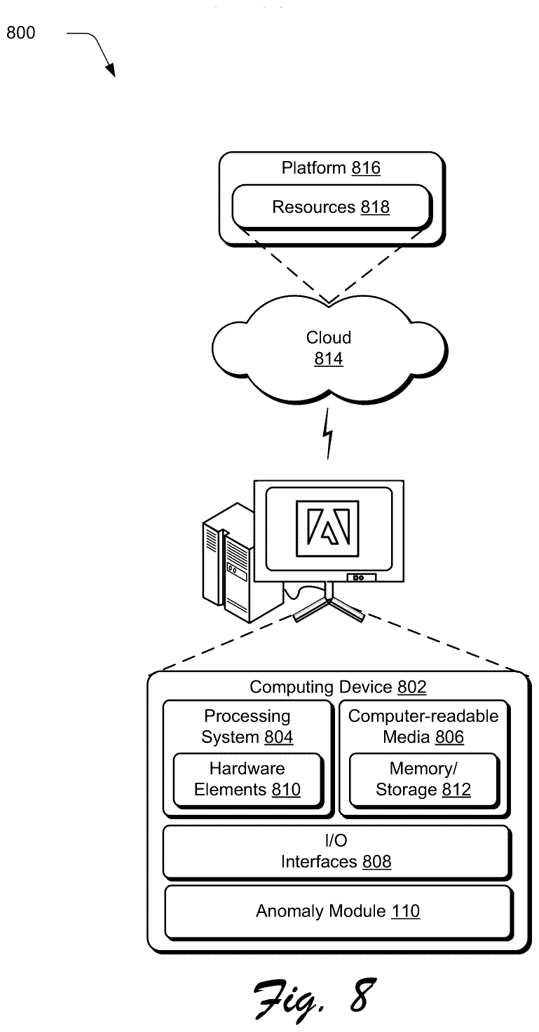

FIG. 8 illustrates an example system 800 that includes an example computing device that is representative of one or more computing systems and/or devices that are usable to implement the various techniques described herein. This is illustrated through inclusion of the anomaly module 110. The computing device 802 includes, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interfaces 808 that are communicatively coupled, one to another. Although not shown, the computing device 802 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware elements 810 that are configured as processors, functional blocks, and so forth. This includes example implementations in hardware as an application specific integrated circuit or other logic device formed using one or more semiconductors. The hardware elements 810 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 806 is illustrated as including memory/storage 812. The memory/storage 812 represents memory/storage capacity associated with one or more computer-readable media. In one example, the memory/storage 812 includes volatile media (such as random access memory (RAM)) and/or nonvolatile media (such as read only memory (ROM), Flash memory, optical disks, magnetic disks, and so forth). In another example, the memory/storage 812 includes fixed media (e.g., RAM, ROM, a fixed hard drive, and so on) as well as removable media (e.g., Flash memory, a removable hard drive, an optical disc, and so forth). The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 810. For example, the computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (for example, one or more computing devices 802 and/or processing systems 804) to implement techniques, modules, and examples described herein.

The techniques described herein are supportable by various configurations of the computing device 802 and are not limited to the specific examples of the techniques described herein. This functionality is also implementable entirely or partially through use of a distributed system, such as over a “cloud” 814 as described below.

The cloud 814 includes and/or is representative of a platform 816 for resources 818. The platform 816 abstracts underlying functionality of hardware (e.g., servers) and software resources of the cloud 814. For example, the resources 818 include applications and/or data that are utilized while computer processing is executed on servers that are remote from the computing device 802. In some examples, the resources 818 also include services provided over the Internet and/or through a subscriber network, such as a cellular or Wi-Fi network.

The platform 816 abstracts the resources 818 and functions to connect the computing device 802 with other computing devices. In some examples, the platform 816 also serves to abstract scaling of resources to provide a corresponding level of scale to encountered demand for the resources that are implemented via the platform. Accordingly, in an interconnected device embodiment, implementation of functionality described herein is distributable throughout the system 800. For example, the functionality is implementable in part on the computing device 802 as well as via the platform 816 that abstracts the functionality of the cloud 814.

What is claimed is:

1. A method comprising:
receiving, by a processing device via a network, time-series data describing continuously observed values separated by a period of time;
computing, by the processing device, updated estimated parameters of a predictive model for the time-series data by performing a rank one update on previously estimated parameters of the predictive model;
generating, by the processing device using the predictive model with the updated estimated parameters, an uncertainty interval for a future observed value;
determining, by the processing device, an observed value corresponding to the future observed value is outside of the uncertainty interval; and
generating, by the processing device, an indication that the observed value is an anomaly.

2. The method as described in claim 1, wherein the rank one update is performed based on an observed value described by the time-series data that is received before the observed value corresponding to the future observed value is received.

3. The method as described in claim 1, wherein the time-series data is non-stationary.

4. The method as described in claim 1, wherein the predictive model is based on an approximate Gaussian process.

5. The method as described in claim 1, wherein the predictive model is implemented using Bayesian linear regression.

6. The method as described in claim 1, wherein the uncertainty interval is generated using a maximum a posteriori estimate.

7. The method as described in claim 1, wherein the updated estimated parameters are computed using exponentially weighted updates that decay based on the period of time.

8. The method as described in claim 7, wherein the exponentially weighted updates have a decay rate based on a fraction of the period of time.

9. The method as described in claim 7, wherein the exponentially weighted updates are used to vary regression coefficients over time.

10. A system comprising:
a memory component; and
a processing device coupled to the memory component, the processing device to perform operations comprising:
receiving, via a network, time-series data describing continuously observed values separated by a period of time;
computing updated estimated parameters of a predictive model for the time-series data by performing a rank one update on previously estimated parameters of the predictive model;
generating, using the predictive model with the updated estimated parameters, an uncertainty interval for a future observed value;
determining an observed value corresponding to the future observed value is outside of the uncertainty interval; and
generating an indication that the observed value is an anomaly.

11. The system as described in claim 10, wherein the time-series data is non-stationary.

12. The system as described in claim 10, wherein the rank one update is performed based on an observed value described by the time-series data that is received before the observed value corresponding to the future observed value is received.

13. The system as described in claim 10, wherein the predictive model is implemented using Bayesian linear regression.

14. The system as described in claim 10, wherein the uncertainty interval is generated using a maximum a posteriori estimate.

15. The system as described in claim 10, wherein the predictive model is based on an approximate Gaussian process.

16. The system as described in claim 10, wherein the updated estimated parameters are computed using exponentially weighted updates that decay based on the period of time.

17. A non-transitory computer-readable storage medium storing executable instructions, which when executed by a processing device, cause the processing device to perform operations comprising:
training a predictive model to generate predicted values for future observed values using training data describing a set of previously observed values of a time-series;
computing updated estimated parameters of the predictive model for time-series data received via a network as describing continuously observed values of the time-series separated by a period of time by performing a rank one update on previously estimated parameters of the predictive model computed based on the training data;
generating, using the predictive model with the updated estimated parameters, a predicted value for a future observed value;
comparing an observed value corresponding to the future observed value with the predicted value; and
generating an indication that the observed value is an anomaly based on comparing the observed value with the predicted value.

18. The non-transitory computer-readable storage medium as described in claim 17, wherein the predictive model is based on an approximate Gaussian process.

19. The non-transitory computer-readable storage medium as described in claim 17, wherein the time-series data is non-stationary.

20. The non-transitory computer-readable storage medium as described in claim 17, wherein updated estimated parameters are computed using exponentially weighted updates that decay based on the period of time.
